(19) United States
(12) Patent Application Publication
(10) Pub. No.: US 2005/0239384 A1
(43) Pub. Date: Oct. 27, 2005

(54) Reshaping fixture for carbide inserts

(75) Inventor: Mark W. Eggart, Oscoda, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: True Setting Sales, Oscoda, MI (US)

(21) Appl. No.: 11/112,036

(22) Filed: Apr. 22, 2005

Related U.S. Application Data
(60) Provisional application No. 60/565,456, filed on Apr. 26, 2004.

(51) Int. Cl. B23P 15/28

(52) U.S. Cl. 451/364

(57) ABSTRACT

The subject invention provides a work support apparatus (20) for re-grinding a corner of a cutting insert (22). The work support apparatus (20) includes a base (24) pivotable between a horizontal position and an inclined position for re-grinding a positive and a negative cutting insert (22). A support lever (26) is mounted to the base (24) and is rotatable about a pivot axis (P). The support lever (26) supports a carrier post (30). An insert holder (32) positions the cutting insert (22) for re-grinding and is supported by the carrier post (30). The insert holder (32) is connected to the carrier post (30) by an adjustable device (36). The insert holder (32) is adjustable along a holder axis (H) perpendicular to the pivot axis (P). The insert holder (32) is adjustable for positioning the corner of the cutting insert (22) to be ground a pre-determined distance from the pivot axis (P) such that the same work support apparatus (20) may be used for grinding various radii into the cutting insert (22).

### CROSS REFERENCE TO RELATED APPLICATIONS

This application claims the benefit of U.S. provisional patent application Ser. No. 60/565,456, filed on Apr. 26, 2004, the disclosure of which is hereby incorporated by reference.

### BACKGROUND OF THE INVENTION

1. Field of the Invention

The subject invention relates to a work support apparatus for re-grinding a cutting insert around a corner, between edges thereof.

2. Description of the Prior Art

The typical work support is supported on a chuck and used in combination with a surface grinder to grind the cutting surfaces into the cutting insert. An example of such a work support apparatus is shown in the U.S. Pat. No. 5,168,661 to Pedersen et. al., (“the '661 patent.”)

The '661 patent discloses a work support apparatus that includes a work holder for supporting the cutting insert. The work holder is secured to a work spindle that is journaled for rotation in a work head. The work head is rotatably mounted to a base for rotation about a pivot axis extending upwardly from the base. The base is mounted to a table, which is movable in perpendicular and parallel directions relative to the surface grinder. The surface grinder is movable vertically relative to the table. A plurality of electric motors controls the movement of the table and surface grinder, and an operator controls the electric motors. The cutting insert is ground by rotating the gear about the pivot axis and into engagement with the surface grinder.

When using a work support apparatus as disclosed in the '661 patent to grind cutting inserts, the radius of the corner is determined by the distance between the pivot axis and the surface grinder. If a different radius is desired, an alternative work support having a different relative spacing between the pivot axis and the surface grinder must be installed on the table.

### SUMMARY OF THE INVENTION AND ADVANTAGES

The subject invention provides a work support apparatus for re-grinding a cutting insert around a corner between edges. The work support apparatus includes a base. A support lever is pivotably attached to the base for rotation about a pivot axis. The pivot axis extends upwardly from the base. A carrier post extends upwardly from the support lever in spaced relationship to the pivot axis. An insert holder is disposed on the carrier post and extends along a holder axis perpendicular to the pivot axis. The insert holder supports the cutting insert such that the pivot axis extends therethrough. An adjustable device interconnects the insert holder and the carrier post for adjusting the position of the insert holder along the holder axis relative to the pivot axis for determining the radius of the corner of the cutting insert to be re-ground into the cutting insert.

The subject invention also provides a method of re-grinding a cutting insert around a corner between edges. The method comprises the steps of pre-positioning the cutting insert in a datum position relative to the pivot axis, moving the cutting insert into kissing engagement with a grinding wheel to a start position, moving the cutting insert away from the grinding wheel, and moving the cutting insert back into engagement with the grinding wheel and past the start position to grind the corner. The method further includes the step of adjusting the position of the cutting insert a pre-determined distance from the datum position such that the pivot axis extends through the cutting insert to pre-determine the radius of the corner to be ground.

Accordingly, the subject invention provides a work support apparatus for grinding a cutting insert that is adjustable to provide for grinding differing radii on the cutting insert without using different work supports for the different radii. The subject invention is therefore a more efficient and cost effective work support apparatus for re-grinding cutting inserts.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side view of the work support apparatus;

FIG. 2 is an exploded side view of the work support apparatus;

FIG. 3 is a front view of a stop plate of the work support apparatus;

FIG. 4 is a side view of the stop plate.

FIG. 5 is a top view of an insert holder of the work support apparatus;

FIG. 6 is a side view of the insert holder;

FIG. 7 is a back view of a carrier post of the work support apparatus;

FIG. 8 is a side view of the carrier post;

FIG. 9 is a top view of a support lever of the work support apparatus;

FIG. 10 is a side view of the support lever;

FIG. 11 is a top view of a base of the work support apparatus;

FIG. 12 is a side view of the base;

FIG. 13 is a top view of a clamping device of the work support apparatus;

FIG. 14 is a side view of the clamping device.

### DETAILED DESCRIPTION OF THE PREFERRED EMBODIMENT

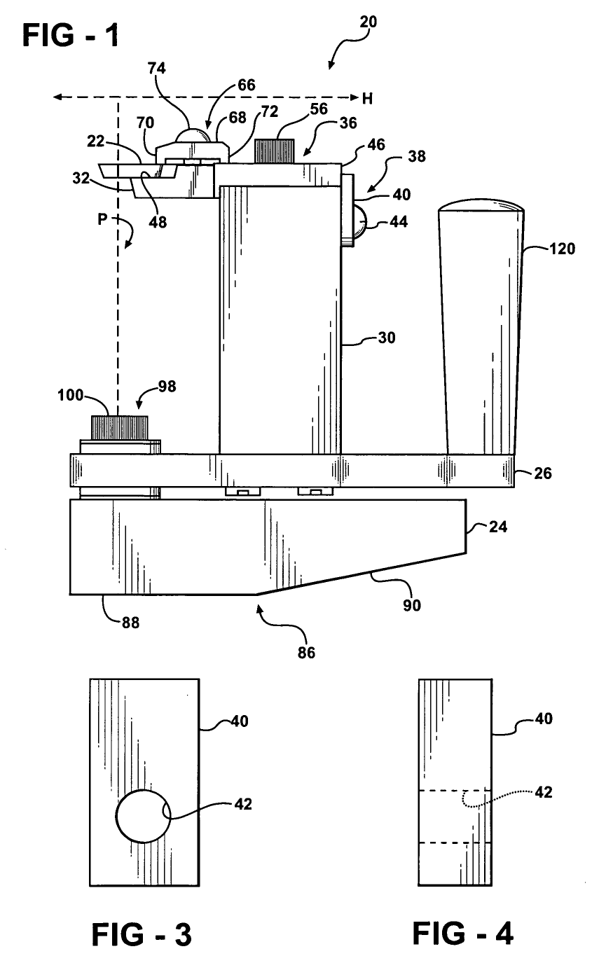

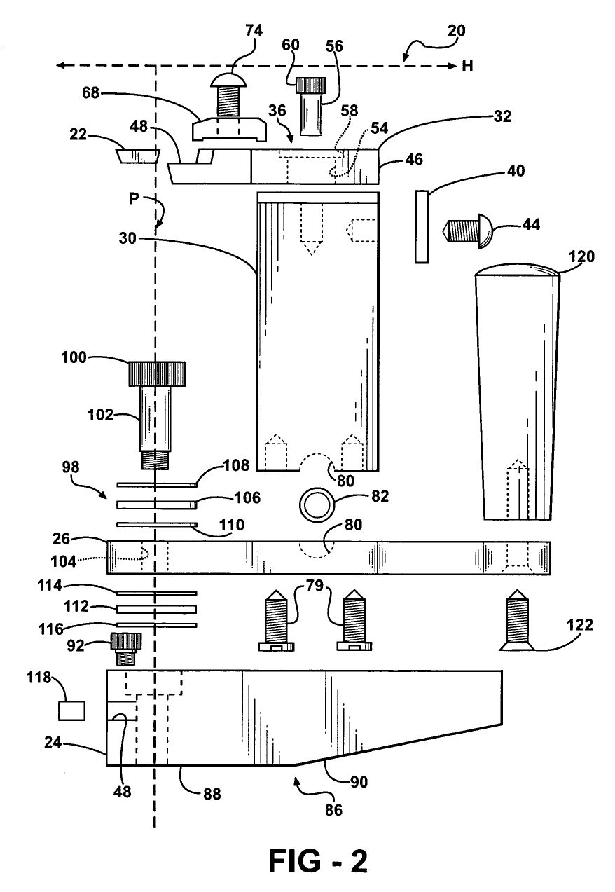

Referring to the figures, wherein like numerals indicate like or corresponding parts throughout the several views, a work support apparatus is generally shown at 20 in FIGS. 1 and 2. The work support apparatus 20 is for re-grinding a cutting insert 22 around a corner between edges. The work support apparatus 20 includes a base 24. A support lever 26 is pivotably attached to the base 24 for rotation about a pivot axis P extending upwardly from the base 24. A carrier post 30 extends upwardly from the support lever 26 in spaced relationship to the pivot axis P. An insert holder 32 is secured to the carrier post 30 and extends along a holder axis H perpendicular to the pivot axis P for supporting the cutting insert 22. The cutting insert 22 is positioned on the insert holder 32 such that the pivot axis P extends through the corner of the cutting insert 22. The work support apparatus 20 includes an adjustable device, generally shown at 36, interconnecting the insert holder 32 and the carrier post 30. The adjustable device 36 adjusts the position of the insert holder 32 along the holder axis H relative to the pivot axis P for determining the radius of the corner to be ground into the cutting insert 22.

The work support apparatus 20 further includes an indexing device, generally shown at 38, for positioning the insert holder 32 in a datum position parallel to and spaced radially from the pivot axis P. As best shown in FIGS. 3 and 4, the indexing device 38 includes a stop plate 40 defining a through bore 42. Referring back to FIGS. 1 and 2, a stop plate fastener 44 attaches the stop plate 40 to the carrier post 30 such that a top end of the stop plate 40 extends above a top surface of the carrier post 30.

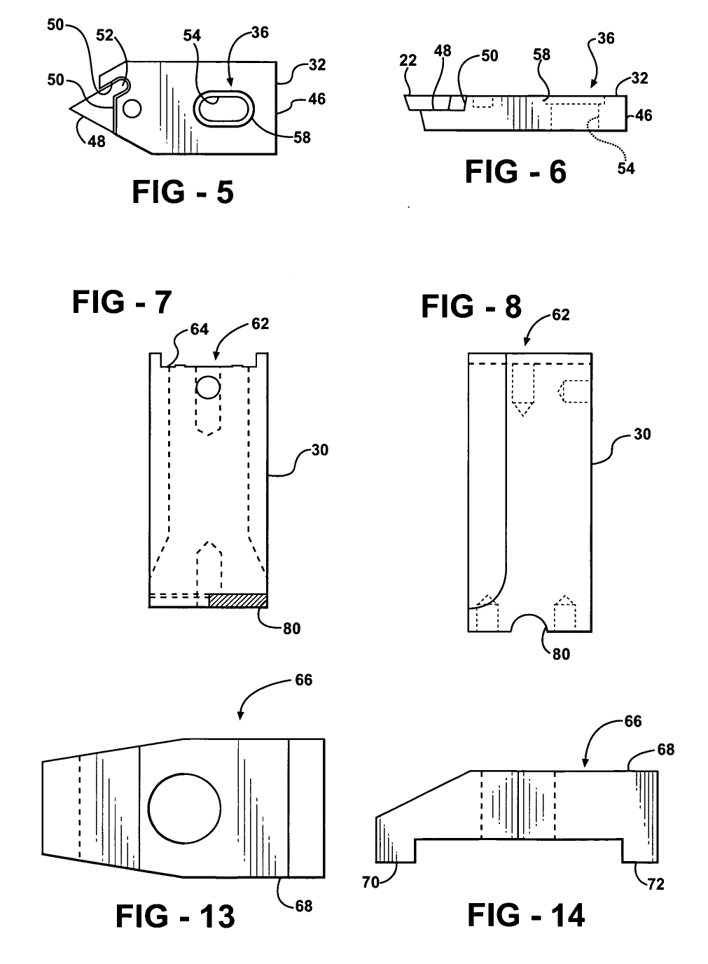

As best shown in FIGS. 5 and 6, the insert holder 32 includes a locating surface 46 parallel to the pivot axis P. A recess 48 is adjacent the pivot axis P for retaining the cutting insert 22 therein. The recess 48 includes at least one locating edge 50 and a pocket 52 located adjacent the at least one locating edge 50. The locating edges position the cutting insert 22 within the recess 48. The pocket 52 facilitates the positioning of the cutting insert 22 within the recess 48. Referring back to FIG. 1, the locating surface 46 abuts the stop plate 40 to position the insert holder 32 in the datum position. The insert holder 32 extends from the locating surface 46 forward to a distal end adjacent the pivot axis P.

Referring to FIGS. 2, 5, and 6, the adjustable device is generally shown at 36 and includes an elongated opening 54 having a length parallel to the holder axis H. A fastener 56 passes through the elongated opening 54 to secure the insert holder 32 to the carrier post 30. The insert holder 32 is adjustable axially along the holder axis H. The adjustable device 36 includes an indentation 58 disposed about the elongated opening 54 such that a head portion 60 of the fastener 56 is disposed within the indentation 58.

When operating the work support apparatus 20, an operator moves the insert holder 32 forward from the stop plate 40 to place a shim between the locating surface 46 and the stop plate 40. The operator will then move the insert holder 32 back toward the stop plate 40 tightly sandwiching the shim between the locating surface 46 and the stop plate 40.

As best shown in FIGS. 7 and 8, the carrier post 30 includes a holder guide, generally shown at 62, for guiding the insert holder 32 along the holder axis H. The holder guide 62 includes a holder channel 64 defined in the carrier post 30. The holder channel 64 receives the insert holder 32 such that at least one side of the insert holder 32 engages at least one side of the holder channel 64.

Referring back to FIGS. 1 and 2, the work support apparatus 20 includes a clamping device, generally shown at 66, for securing the cutting insert 22 to the insert holder 32. The clamping device 66 includes a clamping plate 68 having a first clamping ridge 70 and a second clamping ridge 72. The clamping plate 68 is attached to the insert holder 32 by a clamping fastener 74. The first clamping ridge 70 contacts the cutting insert 22 positioned within the recess 48. The second clamping ridge 72 contacts a top surface of the insert holder 32. The clamping fastener 74 is tightened to apply a downward force to the clamping plate 68. The clamping plate 68 transfers the downward force to the first 70 and second 72 clamping ridges, thereby securing the cutting insert 22 to the insert holder 32.

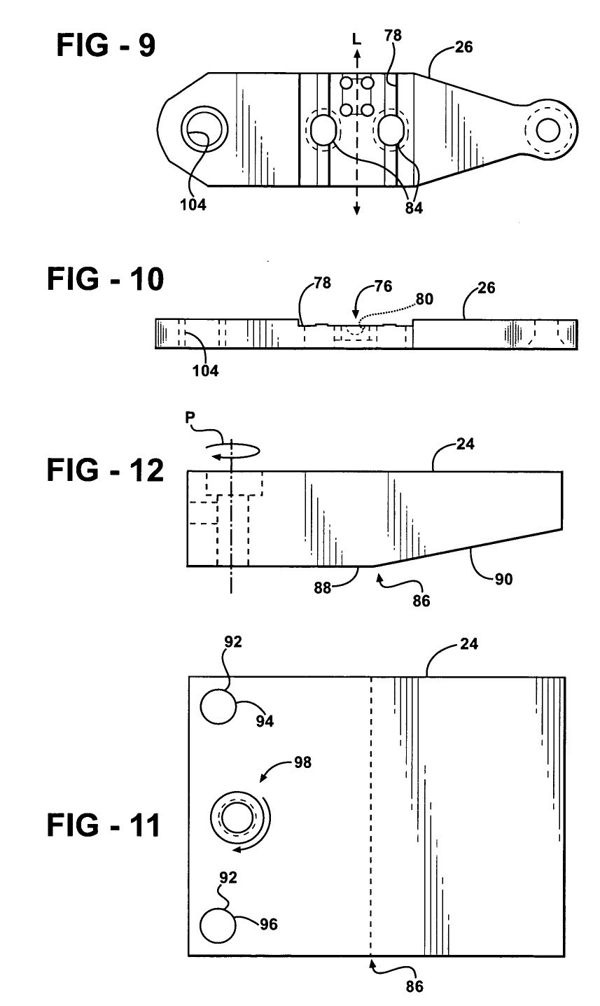

Referring to FIGS. 9 and 10, the support lever 26 includes a carrier post guide, generally shown at 76. The carrier post guide 76 includes a longitudinal axis L perpendicular to the holder axis H for guiding the carrier post 30 along the longitudinal axis L. The carrier post guide 76 includes a carrier post channel 78 in the support lever 26 for receiving the carrier post 30 therein. Referring to FIG. 2, at least one side of the carrier post 30 engages at least one side of the carrier post channel 78. At least one screw 79 passes through an elongated bore 84 defined by the support lever 26 and into threaded engagement with the carrier post 30 for securing the carrier post 30 to the support lever 26. The elongated bore 84 allows adjustment of the carrier post 30 along the longitudinal axis L while still maintaining a secure connection between the support lever 26 and the carrier post 30.

The carrier post 30 and the support lever 26 define a threaded bore 80 therebetween. An adjustment screw 82 is in threaded engagement with the threaded bore 80. The adjustment screw 82 axially adjusts the carrier post 30 by threading the adjustment screw 82 inwardly or outwardly from within the threaded bore 80. The carrier post 30 is adjusted along the longitudinal axis L of the carrier post guide 76 for centering the insert holder 32 on the holder axis H.

As best shown in FIGS. 11 and 12, the base 24 includes a rotatable device, generally shown at 86, for rotating the cutting insert 22 between a horizontal position and an inclined position. The rotatable device 86 rotates the cutting insert 22 to re-grind the corner of both a positive and a negative cutting insert 22. The rotatable device 86 includes a first bottom surface 88 of the base 24 and a second bottom surface 90 of the base 24. The first bottom surface 88 is perpendicular to the pivot axis P for positioning the cutting insert 22 in the horizontal position. The second bottom surface 90 is inclined at an angle relative to the pivot axis P for positioning the cutting insert 22 in the inclined position. Preferably, the second bottom surface 90 is inclined at an eleven-degree angle relative to the first bottom surface 88.

The work support apparatus 20 includes at least one stop 92 attached to the base 24 for limiting rotation of the support lever 26 about the pivot axis P. Preferably, the work support apparatus 20 includes a first stop 94 and a second stop 96 disposed on each side of the support lever 26 to limit rotation of the support lever 26 in both a clockwise and a counterclockwise direction.

Referring back to FIGS. 1 and 2, a pivotable connection is generally shown at 98. The pivotable connection 98 attaches the support lever 26 to the base 24 for rotation about the pivot axis P. The pivotable connection 98 includes a pivot fastener 100 having a smooth shank portion 102 that passes through an aperture 104 defined by the support lever 26 and into threaded engagement with the base 24. A head portion of the pivot fastener 100 is spaced from the support lever 26 by a first thrust bearing 106 sandwiched between a first thrust washer 108 and a second thrust washer 110. Likewise, the support lever 26 is spaced from the base 24 by a second thrust bearing 112 sandwiched between a third thrust washer 114 and a fourth thrust washer 116. The pivot fastener 100 passes through the first thrust washer 108, the first thrust bearing 106, the second thrust washer 110, the support lever 26, the third thrust washer 114, the second thrust bearing 112, and the fourth thrust washer 116 such that the smooth shank portion 102 of the pivot fastener 100 extends downward into the base 24. A setscrew 118 is advanced into a threaded recess 48 in a front surface of the base 24 and is tightened against the pivot fastener 100 to secure the pivot fastener 100 in place.

The work support apparatus 20 includes a handle 120 attached to the support lever 26 for operating the work support apparatus 20. The handle 120 is attached to the support lever 26 by a handle fastener 122 passing through the support lever 26 and into threaded engagement with the handle 120.

The work support apparatus 20 as described above is intended for use with a magnetic chuck. The work support apparatus 20 can be used to re-grind a variety of different shaped cutting inserts 22, including square and triangular inserts. A different insert holder 32 is used for the different shaped cutting inserts 22.

The subject invention also provides a method of re-grinding a cutting insert 22 around a corner between a first and a second edge of the cutting insert 22. When operating the work support apparatus 20, the operator must first determine the stock removal thickness necessary to sharpen the cutting insert 22. This is the necessary amount of material to be removed to grind a sharp corner. Next, the operator must determine the existing radius of the cutting insert 22 to be ground. It is preferable to use radius gauges or and optical comparator to determine the existing radius. A proposed radius is then calculated by adding the stock removal thickness to the existing radius. A shim thickness is calculated by an equation specific to the shape of the cutting insert. As shown in the Figures, for a triangular cutting insert, the shim thickness is calculated by multiplying the proposed radius by two. The cutting insert 22 is initially positioned in a datum position parallel to and spaced radially from the pivot axis P. The shim is inserted between the locating surface 46 on the insert holder 32 and the stop plate 40 to move the insert holder 32 from the datum position to a grinding position. The cutting insert 22 is positioned in the insert holder 32 firmly against the locating edges and securely clamped in place.

The work support apparatus 20 is positioned on the magnetic chuck in either the horizontal position if the operator is grinding a negative cutting insert 22 or the inclined position if the operator is grinding a positive cutting insert 22. The corner of the cutting insert 22 is positioned in the lower right quadrant of the surface grinder. The operator then advances the cutting insert 22 inward towards the surface grinder until the cutting insert 22 is in kissing engagement with the surface grinder in a start position. At least one dog stop 92 is placed for repeating the start position. The cutting insert 22 is then withdrawn from the surface grinder. To sharpen the cutting insert 22, the surface grinder is activated and the operator urges the cutting insert 22 back into the surface grinder while rotating the cutting insert 22 back and forth about the pivot axis P until the corner is re-ground.

The foregoing invention has been described in accordance with the relevant legal standards; thus, the description is exemplary rather than limiting in nature. Variations and modifications to the disclosed embodiments may become apparent to those skilled in the art and do come within the cope of the invention. Accordingly, the scope of legal protection afforded this invention can only be determined by studying the following claims. In addition, the reference numerals in the claims are merely for convenience and are not to be read in any way as limiting.

1. A work support apparatus (20) for re-grinding a cutting insert (22) around a corner between edges comprising:
a base (24),
a support lever (26) pivotably attached to said base (24) for rotation about a pivot axis (P) extending upwardly from said base (24),
a carrier post (30) extending upwardly from said support lever (26) in spaced relationship to said pivot axis (P),
an insert holder (32) on said carrier post (30) extending along a holder axis (H) perpendicular to said pivot axis (P) for supporting the cutting insert (22) with the pivot axis (P) extending through the corner thereof, and
an adjustable device (36) interconnecting said insert holder (32) and said carrier post (30) for adjusting the position of said insert holder (32) along said holder axis (H) relative to said pivot axis (P) for determining the radius of the corner of the cutting insert (22) to be re-ground into the cutting insert (22).

2. An apparatus as set forth in claim 1 wherein said apparatus includes an indexing device (38) for positioning said insert holder (32) in a datum position parallel to and radially from said pivot axis (P).

3. An apparatus as set forth in claim 2 wherein said insert holder (32) includes a locating surface (46) parallel to and spaced radially from said pivot axis (P) and said indexing device (38) includes a stop plate (40) for abutting against said locating surface (46) to position said insert holder (32) in said datum position.

4. An apparatus as set forth in claim 3 wherein said adjustable device (36) includes an elongated opening (54) having a length parallel to said holder axis (H) and a fastener (56) passing therethrough for securing said insert holder (32) to said carrier post (30) such that said insert holder (32) moves axially along said holder axis (H) for placing a shim between said locating surface (46) and said stop plate (40).

5. An apparatus as set forth in claim 4 wherein said carrier post (30) includes a holder guide (62) for guiding said insert holder (32) along said holder axis (H).

6. An apparatus as set forth in claim 5 wherein said holder guide (62) includes a holder channel (64) in said carrier post (30) for receiving said insert holder (32) therein such that at least one side of said insert holder (32) engages at least one side of said holder channel (64).

7. An apparatus as set forth in claim 5 wherein said insert holder (32) includes a recess (48) adjacent said pivot axis (P) for retaining the cutting insert (22).

8. An apparatus as set forth in claim 7 wherein said recess (48) includes at least one locating edge (50) for positioning the cutting insert (22) within said recess (48).

9. An apparatus as set forth in claim 8 wherein said recess (48) includes a pocket (52) adjacent said locating edge for facilitating the proper positioning of the cutting insert (22) within said recess (48).

10. An apparatus as set forth in claim 9 wherein said stop plate (40) is attached to said carrier post (30).

11. An apparatus as set forth in claim 10 wherein said insert holder (32) extends from said locating surface (46) forward to a distal end adjacent said pivot axis (P).

12. An apparatus as set forth in claim 11 wherein said apparatus includes a clamping device (66) for securing the cutting insert (22) to said insert holder (32).

13. An apparatus as set forth in claim 12 wherein said apparatus includes a rotatable device (86) for rotating the cutting insert (22) between a horizontal position and an inclined position.

14. An apparatus as set forth in claim 13 wherein said rotatable device (86) includes a first bottom surface (88) on said base (24) perpendicular to said pivot axis (P) for positioning the cutting insert (22) in a horizontal position.

15. An apparatus as set forth in claim 13 wherein said rotatable device (86) includes a second bottom surface (90) on said base (24) inclined at an angle relative to said pivot axis (P) for positioning the cutting insert (22) in an inclined position.

16. An apparatus as set forth in claim 15 wherein said second bottom surface (90) is inclined at an eleven-degree angle relative to said first bottom surface (88).

17. An apparatus as set forth in claim 16 wherein said adjustable device (36) defines an indentation (58) disposed about said elongated opening (54) such that a head portion (60) of said fastener (56) is disposed within said indentation (58).

18. An apparatus as set forth in claim 17 wherein said apparatus includes at least one stop (92) attached to said base (24) for limiting rotation of said support lever (26) about said pivot axis (P).

19. An apparatus as set forth in claim 18 wherein said apparatus includes a handle (120) attached to said support lever (26).

20. An apparatus as set forth in claim 1 wherein said support lever (26) includes a carrier post guide (76) having a longitudinal axis (L) perpendicular to said holder axis (H) for guiding said carrier post (30) along said longitudinal axis (L).

21. An apparatus as set forth in claim 20 wherein said carrier post guide (76) includes a carrier post channel (78) in said support lever (26) for receiving said carrier post (30) therein such that at least one side of said carrier post (30) engages at least on side of said carrier post channel (78).

22. An apparatus as set forth in claim 21 wherein said carrier post (30) and said support lever (26) define a threaded bore (80) therebetween.

23. An apparatus as set forth in claim 22 wherein said apparatus includes an adjustment screw (82) in threaded engagement with said threaded bore (80) for axially adjusting said carrier post (30) along said longitudinal axis (L) of said carrier post guide (76).

24. A method of re-grinding a cutting insert (22) around a corner between edges comprising the steps of:
pre-positioning the cutting insert (22) in a datum position relative to a pivot axis (P),
moving the cutting insert (22) into kissing engagement with a grinding wheel to a start position,
moving the cutting insert (22) away from the grinding wheel,
moving the cutting insert (22) back into engagement with the grinding wheel and past the start position to grind the corner, and
adjusting the position of the cutting insert (22) a pre-determined distance from the datum position such that the pivot axis (P) extends through the cutting insert (22) to pre-determine the radius of the corner to be ground.

25. A method as set forth in claim 24 wherein said step of adjusting the position of the cutting insert (22) a pre-determined distance from the datum position is further defined as adjusting the position of the cutting insert (22) a pre-determined distance from the datum position relative to the shape of the cutting insert (22).
